(19) United States
(12) Patent Application Publication
(10) Pub. No.: US 2025/0055951 A1
(43) Pub. Date: Feb. 13, 2025

(54) MANAGEMENT DEVICE, TASK MANAGEMENT SYSTEM, AND TASK MANAGEMENT METHOD

(71) Applicant: Sharp Kabushiki Kaisha, Osaka (JP)

(72) Inventors: MASANORI HAMAMOTO, Osaka (JP); Makoto SEKIYA, Osaka (JP)

(21) Appl. No.: 18/777,551

(22) Filed: Jul. 19, 2024

(30) Foreign Application Priority Data
Aug. 9, 2023 (JP) 2023-130459

(51) Int. Cl. H04N 1/00

(52) U.S. Cl. CPC H04N 1/0096; H04N 1/00427

(57) ABSTRACT

A management device capable of communicating with a device to be managed that performs a task includes a storage that stores a task list used to manage the task, and a controller. The controller acquires the task to be performed in the device to be managed and information regarding the device to be managed, generates a task group in a case that no task group is present to which the acquired task belongs, and registers the acquired task in the task list in a case that a task group is present to which the acquired task belongs, and the task for the device to be managed is not present in the task group.

### INCORPORATION BY REFERENCE

The disclosure is based on Japanese Patent Application No. 2023-130459 filed in Japan on Aug. 9, 2023, the contents of which are incorporated herein by reference.

### BACKGROUND

The disclosure relates to a management device, a task management system, and the like.

For example, a system is known that remotely manages an image forming device to which a central management device is connected.

### SUMMARY

An object of the disclosure is to provide a management device and the like capable of appropriately managing a task and the like performed in a device, for example.

The disclosure provides a management device capable of communicating with a device to be managed that performs a task, the management device including a storage that stores a task list used to manage the task; and a controller, wherein the controller acquires the task to be performed in the device to be managed and information regarding the device to be managed, generates a task group in a case that no task group is present to which the acquired task belongs, and registers the acquired task in the task list in a case that a task group is present to which the acquired task belongs, and the task for the device to be managed is not present in the task group.

The disclosure provides a task management system including a terminal device that receives an indication to perform a task to a device to be managed, the device to be managed that performs the task, and a management device that stores a task list used to manage the task, wherein the management device acquires the task to be performed in the device to be managed and information regarding the device to be managed, generates a task group in a case that no task group is present to which the acquired task belongs, and registers the acquired task in the task list in a case that a task group is present to which the acquired task belongs, and the task for the device to be managed is not present in the task group, and the device to be managed performs the task registered in the task list.

According to the disclosure, for example, a system can be provided that is capable of appropriately managing a task and the like performed in a device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an overview of a system according to a first embodiment.

FIG. 2 is a diagram illustrating a configuration of hardware of a server device that is a management device according to the first embodiment.

FIG. 3 is a diagram illustrating a configuration of hardware of an image forming device of the first embodiment.

FIG. 4 is a diagram illustrating a configuration of hardware of a terminal device of the first embodiment.

FIG. 5 is a diagram illustrating a configuration of software according to the first embodiment.

FIG. 6 is a diagram illustrating an example of device information according to the first embodiment.

FIG. 7A is a diagram illustrating an example of a task list according to the first embodiment.

FIG. 7B is a diagram illustrating an example of a group determination table according to the first embodiment.

FIG. 7C is a diagram illustrating an example of a task group list according to the first embodiment.

FIG. 8 is a diagram for describing a task according to the first embodiment.

FIG. 9 is a diagram for describing a flow of an entire system according to the first embodiment.

FIG. 10 is a diagram for describing task management processing according to the first embodiment.

FIG. 11 is a diagram for describing a screen transition according to the first embodiment.

FIG. 12 is a diagram for describing an example of a display screen according to the first embodiment.

FIG. 13 is a diagram for describing an example of a display screen according to the first embodiment.

FIG. 14 is a diagram for describing an example of a display screen according to the first embodiment.

FIG. 15 is a diagram for describing an example of a display screen according to the first embodiment.

FIG. 16 is a diagram for describing an example of a display screen according to the first embodiment.

FIG. 17 is a diagram for describing an example of a display screen according to the first embodiment.

FIG. 18 is a diagram for describing an example of a display screen according to the first embodiment.

FIG. 19 is a diagram for describing a flow of task management processing according to a second embodiment.

FIG. 20 is a diagram for describing an example of a task list group according to a third embodiment.

### DETAILED DESCRIPTION

An embodiment of the disclosure will be described below with reference to the drawings. Note that the embodiment described below is one embodiment that provides the disclosure, and the content of the disclosure is not to be interpreted as being limited based on the description below.

In general, a system is known that manages, in a device to be managed (target device), a task performed based on an operation indication from a user. A request related to a task based on an operation indication from a user is transmitted from a management device that controls and manages a task for a target device to be managed. For example, in a case that the management device and the target device are always connected to each other, a request for a task is basically immediately transmitted from the management device to the target device. Then, the management device can acquire a status of the task from the target device in real time. The management device is capable of interactively displaying the performance status of the task in the target device, to the terminal device with which the management device communicates or the display device connected to the management device.

However, the target device and the management device are not necessarily always communicating with each other. For example, in a case that the target device is a device that communicates with the management device at predetermined time intervals, the management device fails to acquire a state of the target device in real time.

For example, the management device and the target device may not be able to directly communicate with each other due to the configuration of a network or the like. In this case, an agent capable of acquiring the state of the target device may be used. However, in the target device using the agent, in a case that the agent is capable of real-time communication, the information regarding the target device can be immediately acquired, but the state of the target device fails to be immediately acquired from a target device not using the agent. Thus, the management device may not be able to immediately acquire the states of all the target devices.

As described above, in a case that the management device and the target device are not always connected to each other, the management device cannot perform real-time communication with the target device, and the management device fails to appropriately manage the target device. In a case that the management device attempts to interactively display the state of the target device, timed out display may occur on the management screen, causing the user to be confused.

A request ID may be assigned to a task performed for each operation indication from the user. However, in this case, in a case that the states of the tasks are displayed in a list (for example, displayed as a management screen), the list becomes complicated, and which operation indication is given to which device may be difficult to understand. A system for solving such a problem will be described below in an embodiment.

### 1. First Embodiment

Next, a first embodiment will be described. For example, a user gives various operation indications to a device to be managed (target device) via the management device. The management device transmits a task based on an operation indication from the user. The management device receives the state of the task in the target device and displays the performance state of the task on the management screen.

At this time, in a case that the target device receives an indication (request) of a task from the management device, timings at which the target devices receive the task vary greatly among the target devices. Therefore, the management device fails to interactively display a result for the state of the task for the target device. In such a case, the management device is provided with a management screen enabling the progress for each target device to be managed and displayed on a per-task basis. In the management screen, tasks are grouped and managed. The present embodiment enables realization of a technique capable of managing the progress of a task not only on a per-task basis but also on a per-task-group basis.

### 1.1 Overview of System

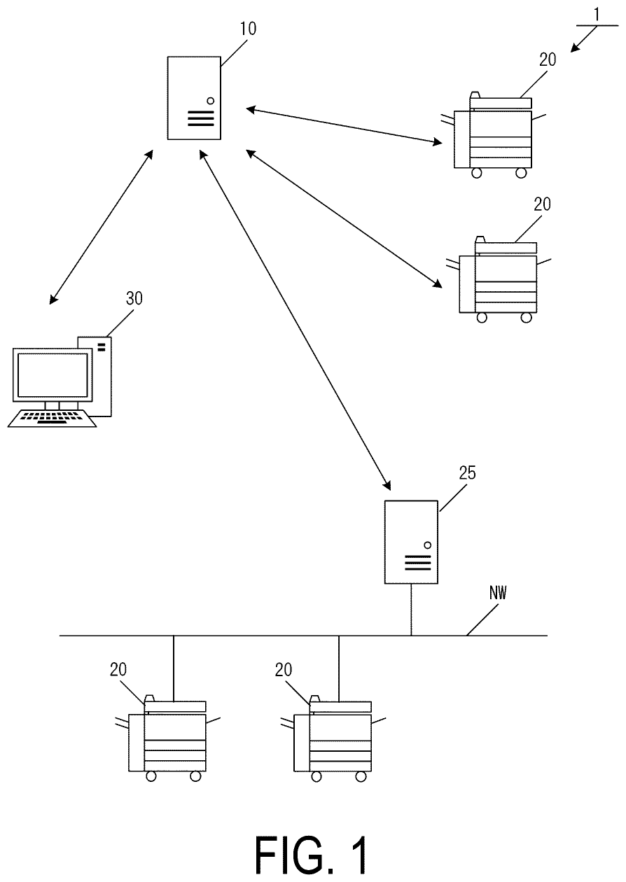

FIG. 1 is a diagram illustrating an overview of a system 1. The system 1 includes a server device 10 serving as a management device and an image forming device 20 serving as a device to be managed.

For example, the server device 10 provides a service (for example, a service for managing a task for a target device) in the present embodiment. For example, the server device 10 may be realized by multiple server devices or a distributed service using a cloud service as long as the server device 10 provides a service.

Target devices to be managed can communicate with the server device 10 via a network. In the present embodiment, the image forming device 20 will be described as an example of the target device. Note that, in addition to the image forming device 20, the target device may be a device such as a display, a digital signage, a WEB camera, a network device, a smartphone, a home appliance such as a refrigerator or an air conditioner, or an automobile.

The image forming device 20 may be directly connected to the server device 10 via a network, or may be connected to the server device 10 via the relay server 25. For example, the relay server 25 acquires the status of a task for the image forming device 20 connected via a network NW or submits a task to the image forming device 20. For example, by providing the relay server 25 in a network such as a company (workplace), a home, or a school, a device in the network is added to the service as a target device.

In the relay server 25, for example, an agent program (hereinafter, simply referred to as an “agent”) is performed that acquires the state of the task for the target device (image forming device 20). The agent may acquire the state of the target device in the network. The agent acquires the state of the task in the target device as one of the states of the target device. The agent may immediately transmit the acquired state of the target device to the server device 10 or may periodically transmit the acquired state to the server device 10.

The agent may be performed in a device different from the target device, such as the relay server 25, or may be performed in the target device. By using the agent, for example, the server device 10 can acquire the state of the target device connected to a portion of the network isolated by a router or the like.

The server device 10 may provide, for example, a management screen for managing tasks on a WEB screen. In this case, the user connects to the server device 10 from the terminal device 30 and manages tasks on the WEB screen.

Here, the task is one or multiple processing operations to be input to the target device based on an operation content from the user. The task may be directly input to the target device (for example, the image forming device 20) or may be input to the target device from the management device (for example, the server device 10). In the present embodiment, an example will be described in which the task is input from the server device 10 serving as a management device to the image forming device 20 serving as a target device.

The terminal device 30 may be realized by any device such as a computer, a tablet, or a smartphone. The terminal device 30 can display a management screen provided by the server device 10 by accessing a predetermined URL using a web browser or the like. The terminal device 30 may use an application to display the management screen based on information provided by the server device 10.

The management screen will be described in detail later, but is a display screen capable of displaying the state of the task for the target device. The management screen includes multiple display screens such as a device list screen, a task registration screen, a guidance screen, a task list screen, and a task detail screen.

Note that the respective devices may communicate with each other by any method. For example, each device may perform communication via the Internet or may perform communication using a mobile communication network. Each device may be a device in the same network arranged in a LAN. Some of the devices may be allocated in the same internal network and others are allocated in an external network. In other words, the target device may directly or indirectly communicate with the server device 10 by using any method.

### 1.2 Hardware Configuration

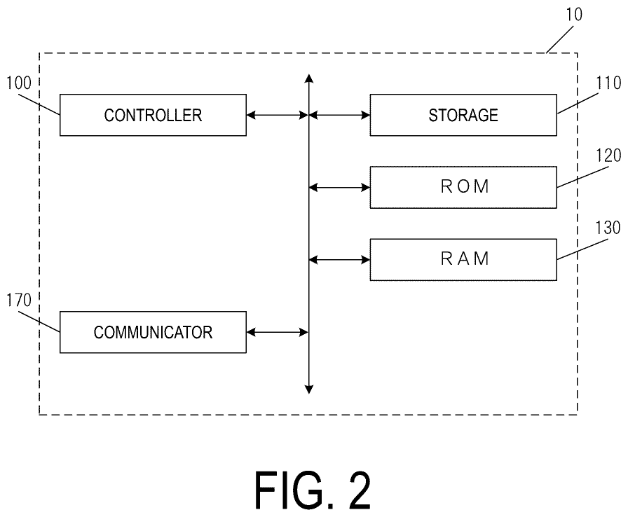

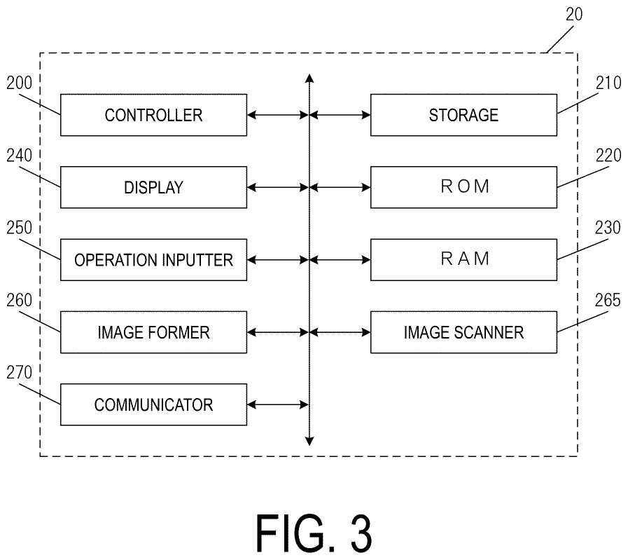

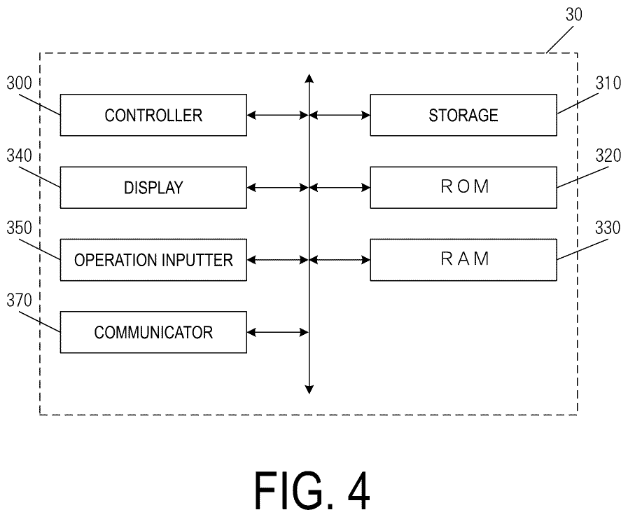

The hardware configuration of each device will be described below with reference to the drawings. FIG. 2 illustrates an example of the server device 10 serving as a management device, FIG. 3 illustrates an example of the image forming device 20 serving as a device to be managed, and FIG. 4 illustrates an example of a terminal device 40.

### 1.2.1 Server Device

As illustrated in FIG. 2, the server device 10 includes a controller 100, a storage 110 as a storage device (storage), a ROM 120 and a RAM 130, and a communicator 170.

The controller 100 controls an entirety of the server device 10. The controller 100 implements various functions by reading and performing various programs stored in the storage device (for example, the storage 110 and the ROM 120). The controller 100 may be implemented by one or multiple control devices/arithmetic devices (such as a Central Processing Unit (CPU), a System on a Chip (SoC)). The controller 100 may include a control circuit.

The storage 110 is a non-volatile storage device capable of storing programs and data. For example, the storage 110 may include a storage device such as a Hard Disk Drive (HDD) or a Solid State Drive (SSD). The storage 110 may be configured as a USB memory that can be connected to an external device. The storage 110 may be, for example, a storage area on a cloud.

The ROM 120 is a non-volatile memory capable of holding the program and data even in a case that the power is turned off.

The RAM 130 is a main memory mainly used in a case that the controller 300 performs processing. The RAM 130 is a rewritable memory that temporarily holds a program read from the storage 110 or the ROM 120 and data including a result of the performance.

The communicator 170 is a communication interface that communicates with other devices. The communicator 170 may be, for example, a network interface capable of providing a wired connection or wireless connection. In the present embodiment, the server device 10 can communicate with other devices via a network connected to the communicator 170.

### 1.2.1 Image Forming Device

As illustrated in FIG. 3, the image forming device 20 includes a controller 200, a storage 210 as a storage device (storage), a ROM 220 and a RAM 230, a display 240, an operation inputter 250, an image former 260, an image scanner 265, and a communicator 270.

The controller 200 controls an entirety of the image forming device 20. The controller 200 implements various functions by reading and performing various programs stored in the storage device (for example, the storage 210 or the ROM 220). The controller 200 may be implemented by, for example, one or multiple control devices/arithmetic devices (Central Processing Unit (CPU), System on a Chip (SOC)). The controller 200 may include a control circuit.

The storage 210 is a non-volatile storage device capable of storing programs and data. For example, the storage 210 may include a storage device such as a Hard Disk Drive (HDD) or a Solid State Drive (SSD). The storage 210 may be configured as a USB memory that can be connected to an external device. The storage 210 may be, for example, a storage area on a cloud.

The ROM 220 is a non-volatile memory capable of holding the program and data even in a case that the power is turned off.

The RAM 230 is a main memory mainly used in a case that the controller 200 of each device performs processing. The RAM 230 is a rewritable memory that temporarily holds a program read from the storage 210 or the ROM 220 and data including a result of the performance.

The display 240 is a display device that can display various types of information and a performance screen. The display 240 may include, for example, a display device such as a Liquid Crystal Display (LCD), an Organic Electro Luminescence (EL) display, or an electrophoresis display. The display 240 includes an interface to which a display device can be connected. For example, the display 240 may include an external display device connected via a High-Definition Multimedia Interface (HDMI) (registered trademark), a Digital Visual Interface (DVI), or a Display Port.

The operation inputter 250 is an operation device that allows a user to input an operation. For example, the operation inputter 250 may be an operation device such as a touch panel integrated with the display 240 or an operation button. The operation inputter 250 may be an operation device such as a keyboard or a mouse. The operation inputter 250 may also include an interface (for example, a Universal Serial Bus (USB)) to which an operation device can be connected. For example, a different operation device (an operation device including a touch panel) may be connected to the image forming device 20.

The image former 260 forms an image on, for example, a recording sheet. The image former 260 includes, for example, an image carrier, and forms an image by forming a toner image on the image carrier and transferring the image on the image carrier onto the recording sheet. The image former 260 may be configured as an image forming device such as a printer. The image former 260 may electronically form an image as an image file.

The image scanner 265 reads a document (image) and outputs the document as image data. The image scanner 265 is, for example, a scanner, and may be a reading device using a Charge Coupled Device (CCD) or a Contact Image Sensor (CIS).

The communicator 270 is a communication interface that communicates with other devices. For example, the communicator 270 may be a network interface capable of providing a wired connection or wireless connection. In the present embodiment, the image forming device 20 can communicate with other devices via the network connected to the communicator 270.

### 1.2.3 Terminal Device

As illustrated in FIG. 4, the terminal device 30 includes a controller 300, a storage 310, ROM 320, and RAM 330 as a storage device (storage), a display 340, an operation inputter 350, and a communicator 370.

The controller 300 controls an entirety of the terminal device 30. The controller 300 implements various functions by reading and performing various programs stored in the storage device (for example, the storage 310 and the ROM 320). The controller 300 may be implemented by, for example, one or multiple control/arithmetic devices (such as Central Processing Unit (CPU), System on a Chip (SoC)). The controller 300 may include a control circuit.

The storage 310 is a non-volatile storage device capable of storing programs and data. For example, the storage 310 may include a storage device such as a Hard Disk Drive (HDD) or a Solid State Drive (SSD). The storage 310 may be configured as a USB memory that can be connected to an external device. The storage 310 may be, for example, a storage area on a cloud.

The ROM 320 is a non-volatile memory capable of holding the program and data even in a case that the power is turned off.

The RAM 330 is a main memory mainly used in a case that the controller 300 performs processing. The RAM 330 is a rewritable memory that temporarily holds a program read from the storage 310 or the ROM 320 and data including a result of the performance.

The display 340 displays various types of information and a performance screen. The display 340 may be, for example, a display device such as a Liquid Crystal Display (LCD), an Organic Electro-Luminescence (EL) display, or an electrophoresis display. The display 340 includes an interface to which a display device can be connected. For example, the display 340 may include an external display device connected via a High-Definition Multimedia Interface (HDMI) (registered trademark), a Digital Visual Interface (DVI), or a Display Port.

The operation inputter 350 is an operation device that allows a user to input an operation. For example, the operation inputter 350 may be an operation device such as a touch panel integrated with the display 340 or an operation button. The operation inputter 350 may be an operation device such as a keyboard or a mouse. The operation inputter 350 may also include an interface (for example, a Universal Serial Bus (USB)) to which the operation device can be connected. For example, the image forming device 20 may be connected to a different operation device (an operation device having a touch panel) instead of the operation inputter 350.

The communicator 370 is a communication interface that communicates with other devices. The communicator 370 may be, for example, a network interface capable of providing a wired connection or wireless connection. In the present embodiment, the terminal device 30 can communicate with another device via a network connected to the communicator 370.

### [1.2.4 Other Configurations]

As described above, the configuration of each device is an example, and is not limited to the configuration described in FIGS. 2 to 4. For example, the display and the operation inputter may be provided in each device as necessary. Each of the above-described configurations may be realized by another device via an interface. The server device 10 and the terminal device 30 may include the same device. For example, the terminal device 30 may function as the server device 10 by installing an application capable of performing processing required in the present embodiment. The relay server 25 illustrated in FIG. 1 may implement the functions of the server device 10 and the terminal device 30 to manage devices connected to a LAN in a company, a home, or the like.

### 1.3 Software Configuration

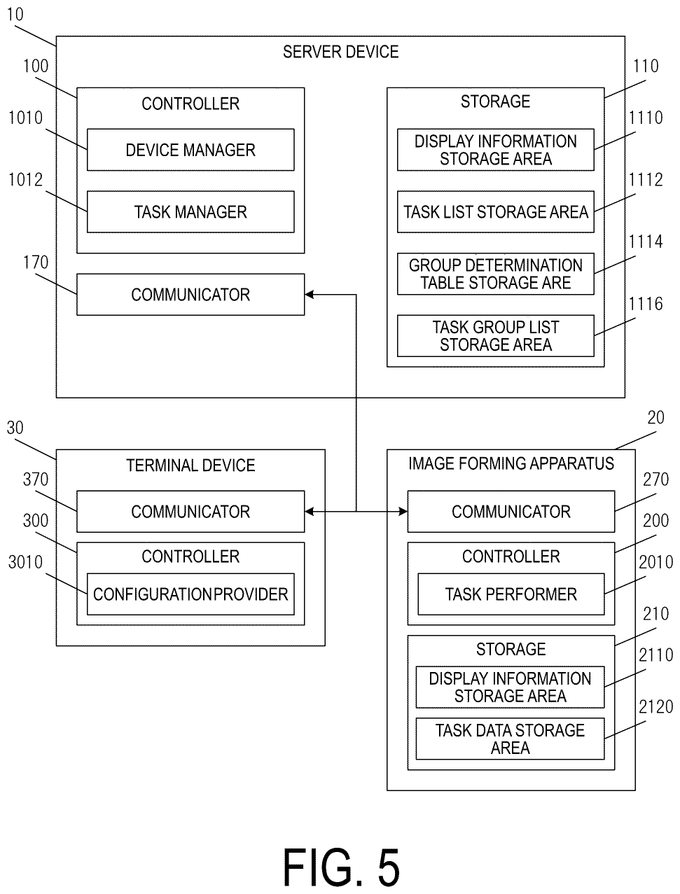

A configuration of main software in each device of the system 1 will be described with reference to FIG. 5. FIG. 5 is a diagram illustrating main software configurations of the server device 10, the image forming device 20, and the terminal device 30. Note that the software configuration illustrated in FIG. 5 mainly describes configurations necessary for the present embodiment, and other configurations are omitted. For example, the image forming device 20 may further include a configuration such as an image processor or a power controller that provides a function necessary for the image forming device 20.

### Server Device

The controller 100 of the server device 10 functions as each of the components described below by performing a program (application) stored in the storage 110 or the ROM 120. The controller 100 implements a device manager 1010 and a task manager 1012, which will be described later, by one or more control devices/arithmetic devices performing processing in accordance with programs and date stored in the storage 110 or the ROM 120.

The device manager 1010 manages information regarding a target device to be managed. For example, the device manager 1010 acquires information regarding a communicable target device (for example, the image forming device 20) and stores the information in a device information storage area 1110.

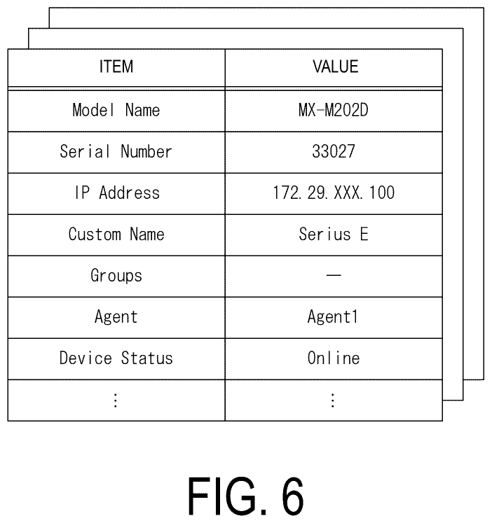

Here, an example of the device information stored in the device information storage area 1110 will be described with reference to FIG. 6. In the device information, items related to devices and values are stored in association with one another. For example, the device information includes a model name of the image forming device 20 being the target device (for example, “MX-M202D” as “Model Name”), identification information for uniquely identifying the image forming device 20 (for example, “33027” as “Serial Number”), a network address of the image forming device 20 (for example, “172. 29. XXX. 100” as “IP Address”), information used by the user to identify the image forming device 20 (name of the image forming device 20 specified by the user) (for example, “Serius E” as “Custom Name”), information for grouping the image forming devices 20 (for example, “-” as “Groups”), information in the image forming device 20 related to an agent for acquiring a device status (for example, “Agent1” as “Agent”), and a status of the image forming device 20 at the time of acquisition (for example, “Online” as “Device Status”).

The information related to the agent indicates, for example, the type of a program of the agent that acquires the status of the image forming device 20 and the type of a service. The agent is performed in the relay server 25. The agent may be performed by any of the image forming devices 20, for example.

The device information storage area 1110 may store the status of the image forming device 20 as described above. The status of the image forming device 20 may be separately stored as the status of the device. Here, the device status of the image forming device 20 may include the following statuses.

### Online

Online [Auto Power Shut-Off]
Cover Open (a status in which the front cover is open)
Toner Low (a status in which the amount of toner is small)
Toner Empty (a status in which no toner remains)
Paper Low (a status in which the number of sheets is small)
Paper Empty (a status in which sheets have run out)
Error (a status in which some error has occurred)

The image forming device 20 may have other device statuses. For example, the device statuses of the image forming device 20 may include “paper discharge tray full”, “paper jam”, “no staples”, or “documents remaining” as detailed statuses. The device status of the image forming device 20 may indicate the status of a power supply. For example, the status of the power supply may indicate a status such as “Offline”, “Shutdown”, or “Sleep” in addition to “Online”.

The status of the image forming device 20 may include the status of a task being performed in the image forming device 20. For example, the device status of the image forming device 20 may include, as the status of the task, the performance status of the task together with the name of the task and the attribute of the task. For example, the task may have the following statuses:
Task has ended (completed) (complete)
Task has not been started (unperformed)
Task is being processed
Task is pending (pending)

Here, the status in which the task has not been started refers to, for example, the status in which, in the server device 10, the task has been input to the target device but the target device has not acquired the task. The status in which the task is pending refers to, for example, the status in which the target device has acquired the task but is not processing the task. The unperformed status of the task may include the status in which the task has not been started in the target device and the status in which the task has been unperformed, including the status in which the task is pending.

The task manager 1012 manages a task list stored in a task list storage area 1112. The task list is a list in which tasks to be performed in the target device (image forming device 20) are registered.

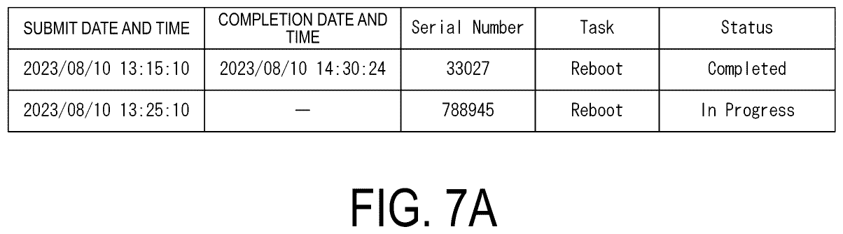

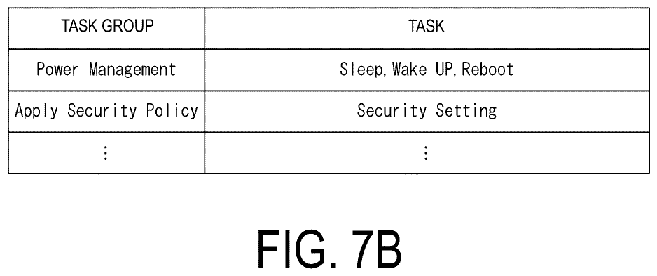

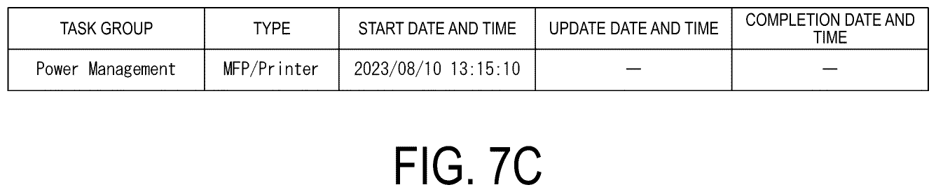

For example, FIG. 7A is a diagram illustrating an example of the task list. The task list stores a submission date and time (for example, “2023 Aug. 10 13:15:10”) indicating the date and time when the task was submitted, a completion date and time (for example, “2023 Aug. 10 14:30:24”) indicating the date and time when the task was completed, identification information (for example, “33027” as “Serial Number”) of a target device (here, the image forming device 20) to perform the task, the type of the task performed by the target device (for example, “Reboot” as “Task”), and the status of the task in the target device (for example, “Completed” as “Status”).

Here, the tasks belong to the respective groups (task groups). For example, the task may have an attribute, and the attribute may be a task group name. The task manager 1012 may store a task group and a task in the table in association with each other.

For example, FIG. 7B is a diagram illustrating an example of a group determination table stored in a group determination table storage area 1114. To the group determination table, tasks (for example, tasks of “Sleep”, “Wake UP”, and “Reboot”) belonging to a task group (for example, “Power Management”) belong.

The name of the task group may be changed by the user. The user may add a new task to the task group or delete any of the tasks included in the task group.

A task group list storage area 1116 stores a task group list related to task groups. FIG. 7C is a diagram illustrating an example of the task group list. The task group list stores a task group name (for example, “Power Management”), a task group type (for example, “MFP/Printer”), a start date and time for the task group (for example, “2023 Aug. 10 13:15:10”), an update date and time for the task group (for example, “−”), and a completion date and time for the task group (for example, “−”).

Here, the image forming device 20 fails to perform tasks belonging to the same task group. Therefore, in a case that the server device 10 registers a task for the image forming device 20 in the task list, the server device 10 does not accept registration of the task in a case that any task in the same task group as the task to be registered is registered in the task list.

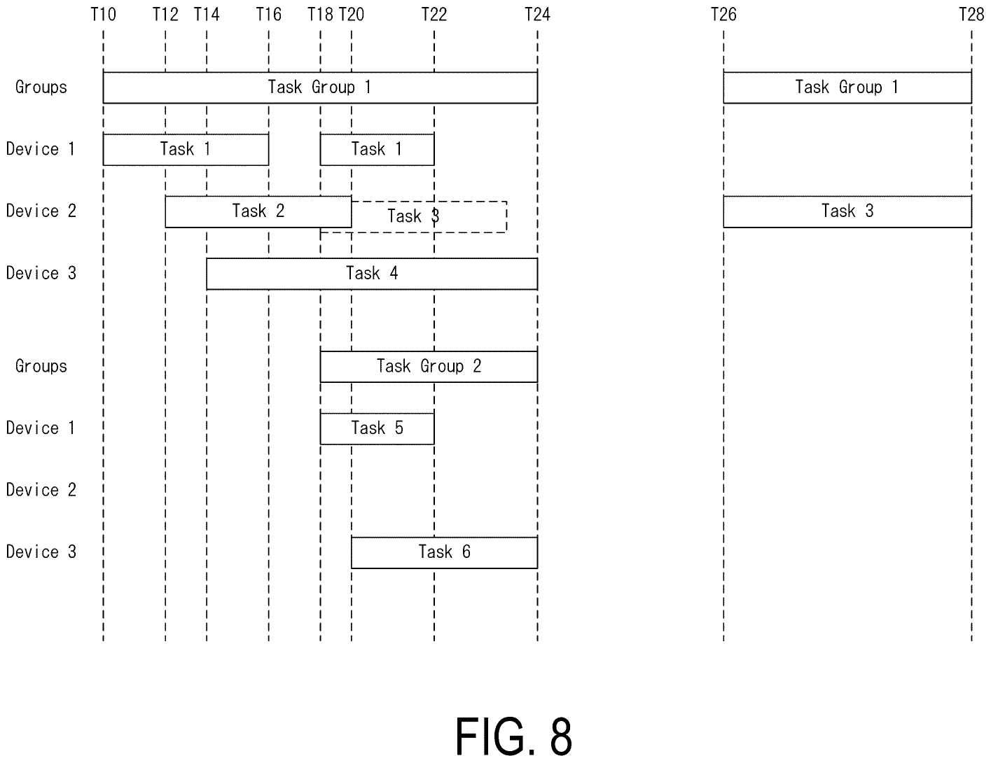

An operation example in which the server device 10 registers a task will be described with reference to FIG. 8. FIG. 8 is a diagram illustrating operations performed by the server device 10 in a case where the server device 10 manages three image forming devices 20 Device1 to Device3 as target devices. Task1 to Task4 are tasks belonging to Task Group1, and Task5 to Task6 are tasks belonging to Task Group2.

First, at time T10, Task1 is registered for Device1 in the task list. Thus, the Device1 can perform the Task1. Note that FIG. 8 illustrates how the target device performs a task in a case that the task is registered in the task list. In other words, in FIG. 8, from time T10, Task1 is in a performance state in Device1.

At this time, Task Group1 which is the task group to which Task1 belongs is generated based on the attribute of Task1. Here, the server device 10 stores Task Group1 in the task group list as the start time T10.

Subsequently, at time T12, Task2 is registered for Device2. The server device 10 determines that no task for Device2 is registered in Task Group1 based on the attribute of Device2, and registers Task2 in the task list. Then, Device2 performs Task2. Similarly, at time T14, Task3 is registered for Device3.

At time T16, Task1 is completed in Device1. However, Task2 and Task4 included in Task Group1 are being performed on the respective devices. Therefore, the Task Group1 is not completed.

Here, at time T18, the user tries to register Task3 with Device2. Based on the attribute of Task3, the server device 10 determines that Task2, which is the same task group (Task Group1) as Task3, has already been performed in Device2. Therefore, the server device 10 cancels the registration of Task3 and does not accept the registration of the task list.

Note that, for example, at time T18, the user tries to register Task5 for Device1. Here, the task group of Task5 is Task Group2, and a task for the same task group as Device1 is not registered in the task list. Therefore, the server device 10 registers Task5 in the task list. Device1 may perform the task of Task5.

At time T18, the user tries to register Task1 for Device1. Here, Task1 has already been completed at time T16. Therefore, since Device1 does not perform a task belonging to Task Group1 at time T18, Task1 is registered in the task list.

At time T22, Task1 and Task5 are completed, but Task Group1 includes Task4 being performed. Task Group2 includes Task6 that is being performed. Thus, at time T22, each task group is not completed.

At time T24, Task4 and Task6 are completed. Therefore, in Task Group1, time T24 is a completion time. In Task Group2, time T24 is the completion time.

Here, at time T26, the user re-registers Task3 that has failed to be accepted at time T18. At this time, no task belonging to Task Group1 is registered in the task list, and thus Task3 is registered in the task list. Then, Task Group1 is newly started. For example, in a case that Task3 is started in Device2 at time T26 and completed at time T28, Task Group1 starts the task at time T26 and ends the task at time T28.

### Image Forming Device

The controller 200 of the image forming device 20 functions as each of the components described below by performing a program (application) stored in the storage 210 or the ROM 220. The controller 200 implements a task performer 2010, which will be described later, by one or more control devices/arithmetic devices performing processing in accordance with programs and date stored in the storage 210 or the ROM 220.

The task performer 2010 performs a task acquired from the server device 10. Here, the controller 200 stores the task acquired from the server device 10 in a task data storage area 2120. Then, the task performer 2010 performs the task stored in the task data storage area 2120.

The device information storage area 2110 stores information related to the device. For example, the controller 200 stores the device information illustrated in FIG. 6 in the device information storage area 2110 and transmits the device information to the server device 10.

### Terminal Device

The controller 300 of the terminal device 30 functions as each of the components described below by performing a program (application) stored in the storage 310 or the ROM 320. The controller 300 implements a configuration provider 3010, which will be described later, by one or more control devices/arithmetic devices performing processing in accordance with programs and date stored in the storage 310 or the ROM 320.

The configuration provider 3010 can connect to the server device 10 via the communicator 370, select a device, and register or delete a job. For example, the configuration provider 3010 displays a management screen displayed by the server device 10 through a WEB browser.

### 1.4 Processing Flow

Now, a processing flow according to the present embodiment will be described with reference to the figures. Note that the processing below will be described with a focus on clarifying the features of the disclosure.

### [1.4.1 Overall Processing]

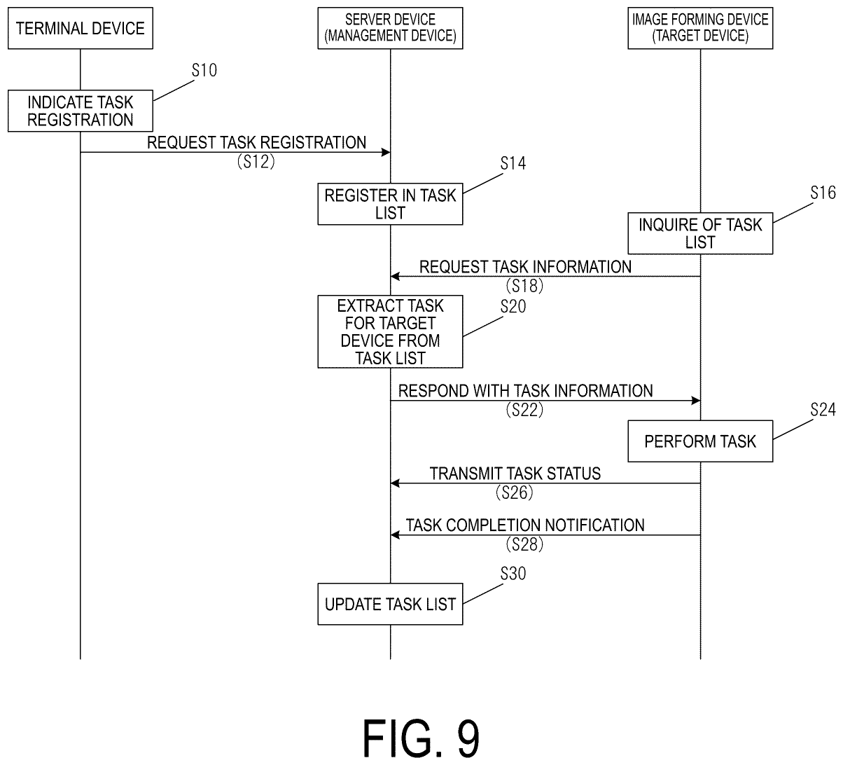

A flow in which the image forming device 20 performs a task will be described with reference to FIG. 9. FIG. 9 illustrates an overall flow in a case that a task is generally performed in the target device. First, the terminal device 30 indicates to the server device 10 serving as the management device to register a task (S10). Here, the terminal device 30 selects a target device (the image forming device 20) on the configuration screen and registers a task to be performed in the target device. Then, the terminal device 30 transmits the information related to the target device and the task to be performed in the target device to the server device 10 as a task registration request.

The server device 10 registers the task in the task list in accordance with the received task registration request (S14). The image forming device 20 serving as the target device inquires of the server device 10 whether any task is addressed to the image forming device 20 by transmitting a task information request to the server device 10 at predetermined time intervals (S16).

Based on the task information request, the server device 10 determines whether the task for the image forming device 20 as the transmission source is registered in the task list. Then, the server device 10 extracts the task for the image forming device 20 that has transmitted the task information request (S20). The server device 10 transmits the extracted task to the image forming device 20 as a task information response (S22).

The image forming device 20 performs the received task (S24). The image forming device 20 may transmit, at a predetermined timing, the status of the task being performed (S26). In a case of completing the performance of the task, the image forming device 20 may transmit a task completion notification (S28). In a case that the task cannot be performed or the task is not completed, the image forming device 20 may transmit, as a task status, information indicating that the task cannot be performed or the task is not completed.

In a case of receiving the task completion notification from the image forming device 20, the server device 10 updates the task list (S30). The server device 10 may update the task list also in a case of receiving the task status from the image forming device 20.

### 1.4.2 Task Management Processing

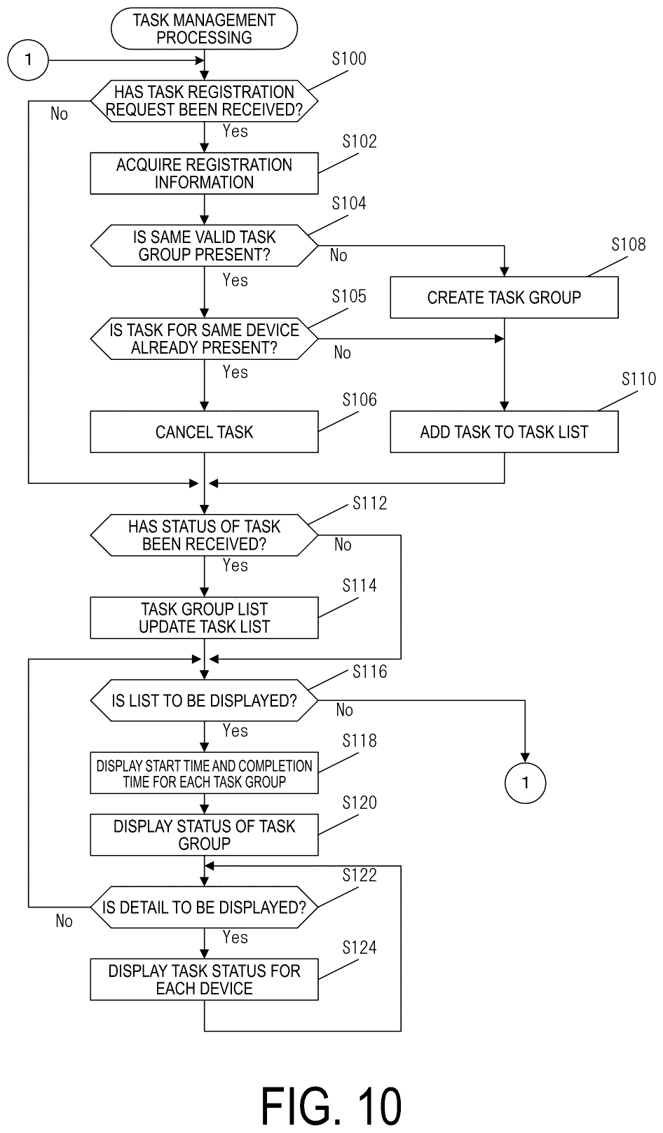

In the present embodiment, for example, in a case that a task is registered in S14 of FIG. 9, the task group is referenced to further determine whether to register the task. Here, task management processing performed by the server device 10 will be described with reference to FIG. 10.

In a case of receiving the task registration request from the terminal device 30 (step S100; Yes), the controller 100 acquires the task registration information from the task registration request (step S102). The task registration information includes information related to a target device to perform a task and a task to be performed in the target device.

The controller 100 determines whether any valid task group is present that is the same as the task group to which the task to be registered acquired in step S102 belongs (step S104).

Here, the valid task group refers to a task group including one or more tasks that are not completed among the tasks belonging to the task group. Therefore, in a case that all the tasks belonging to a task group have been completed, the task group is in a state where the task group is not validly present (invalid task group). Also, in a case that no task is present that belongs to a task group, the task group may be determined not to be validly present.

Here, a method by which the controller 100 determines whether a task group is valid or invalid will be described. First, a possible method for the controller 100 to determine whether the task group is valid is as follows.
(1) In a case that a task group is stored in the task group list and the completion date and time is not stored. In this case, since the task group includes a task in an incomplete status, the controller 100 determines that the task group is valid.
(2) In a case that a task group is stored in the task group list and a task belonging to the task group is registered in the task list. Also in this case, since the task group includes a task in the incomplete status, the controller 100 determines that the task group is valid.

A possible method by which the controller 100 determines that a task group is not valid (determines that the task group is invalid) is as follows.
(1) In a case that a task group is not stored in the task group list, the controller 100 determines that the task group is not valid.
(2) In a case that the completion date and time is stored for the task group stored in the task group list, the controller 100 determines that the task group is not valid. In a case that the completion date and time is stored for the task group in the task group list, all the tasks belonging to the task group are in a completion status.
(3) In a task group stored in the task group list, in a case that all of the tasks belonging to the task group are in the completion status, or in a case that no task belonging to the task group is stored in the task list, the task group is determined not to be valid.

In a case that no valid task group is present that is the same as the task group to which the task to be registered belongs, the controller 100 creates a task group (step S108). Here, in a case that the task group itself is stored in the task group list, the controller 100 may delete the task group list and create a new task group list. The controller 100 may delete the date and time for the task group stored in the task group list once and store the start date and time for the task to be newly registered in the task list as the start date and time for the task group. The start date and time for the task group may be the start date and time when the target device starts performing the task, or may be the date and time when the task is stored in the task list.

Then, the controller 100 registers the task acquired in step S102 in the task list (step S110).

In a case that the same valid task group as the task group to which the task acquired in step S102 (task to be registered in the task list) belongs is already present in the task group list (step S104; Yes), the controller 100 determines whether the task for the same target device is already registered in the task group (step S105). Here, a possible method for determining whether the task for the same target device is already registered is as follows.
(1) The controller 100 extracts tasks of the same target device by referencing the task list. Then, the controller 100 determines whether a task belonging to the same task group as the task to be currently registered is registered in the extracted tasks for the same target device.
(2) The task group list may include, for example, information regarding a target device for which a task is registered. At this time, the controller 100 references the task group list and determines whether the same target device has already been registered in the task group to which the task to be currently registered belongs.

Then, in a case that a task for the target device to perform the task is present in the task group to which the task to be currently registered belongs, the controller 100 cancels the task (step S105; Yes->step S106). In other words, the controller 100 does not register, in the task list, the task acquired in step S102.

Then, in a case that a valid task group is present that is the same as the task group to which the task acquired in step S102 belongs but the task group stored in the task group list includes no task for the target device to perform the task to be currently registered, the current task is added to (registered in) the task list (step S105; No->step S110).

In other words, in the task group list, the tasks submitted to the same target device are not redundantly registered.

Subsequently, in a case of receiving the status of the task, the controller 100 updates the list based on the status of the task (step S112; Yes->step S114). The controller 100 updates the status of the task for the target device included in the task list. The controller 100 updates information included in the task group, for example, the start date and time, the completion date and time, and the like for the task group. The controller 100 may update the status of the task included in the task group. For example, the controller 100 may acquire the number of tasks that are currently performed among the tasks for the target device included in the task group.

In a case that all the tasks belonging to the task group are completed, the controller 100 stores the completion date and time for the task group. The controller 100 may delete the task group in a case that all the tasks belonging to the task group are completed. The controller 100 may delete the task group in a case that all of the tasks belonging to the task group are completed and a new task group is to be created. In a case that a task group is deleted, all of the tasks belonging to the task group may be confirmed complete.

Subsequently, in a case that the user performs a list display operation (step S116; Yes), the controller 100 displays the list. For example, the controller 100 performs list display based on the task group. The controller 100 performs list display based on the tasks based on the task list.

First, the controller 100 displays a task group list. The task group list displays the status of a task for each task group. For example, the controller 100 displays the start time and the completion time included in the task group list for each task group (step S118). Here, the controller 100 displays, as the start time, the time when performance of a task included in the task group is started, the task having started to be performed first in the task group. The controller 100 displays, as the completion time of the task group, the completion time of the task completed last in the task group. For example, in FIG. 8, the start times of the group tasks are times T10, T14, and T26, and the completion times of the group tasks are T24 and T28.

In a case that the status of the task is updated during the processing, the controller 100 may also display the time of the update. The controller 100 may display the time of the update in the task group list based on the update date and time stored in the task group list. For example, the time of the update is one of the times T12 to T22 in FIG. 8.

Subsequently, the controller 100 displays the status of the task group (step S120). For example, the controller 100 extracts, from the task list, the statuses of the tasks included in the task group. Then, the controller 100 updates the status of the task group from the extracted statuses of the tasks. For example, the controller 100 can display, as the status of the task group, whether a task for the task group is being performed or all of the tasks belonging to the task group are completed. In a case that a task belonging to the task group is being performed, the controller 100 may display how many tasks are being performed among the tasks belonging to the task group.

Here, in a case that the operation of the detailed display is performed (step S122; Yes), the controller 100 displays the task list included in the task group (step S124). For example, the controller 100 may display a task list which is a task status for each target device included in the task group. The status of the task for the target device displayed in the task list may include, for example, a status in which the task is being performed, the task is completed, or the task has not been performed yet, or an error.

The above-described task registration may be intended for multiple tasks. For example, the task registration request may further include multiple target devices and tasks to be performed in the target devices. In this case, for each task, steps S102 to S110 may be sequentially performed. For example, in a case that registration of three tasks is requested, processing may be performed in such a manner that the first task and the second task are added to the task list but that only the third task is canceled.

### 1.5 Operation Examples

Now, an operation example will be described using a management screen which is a display screen. Note that, for the operation example, schematic diagrams are provided that describe the types and contents of items displayed on the display screen. Therefore, the display screens in the respective drawings (display screens of different scenes) may display different pieces of information.

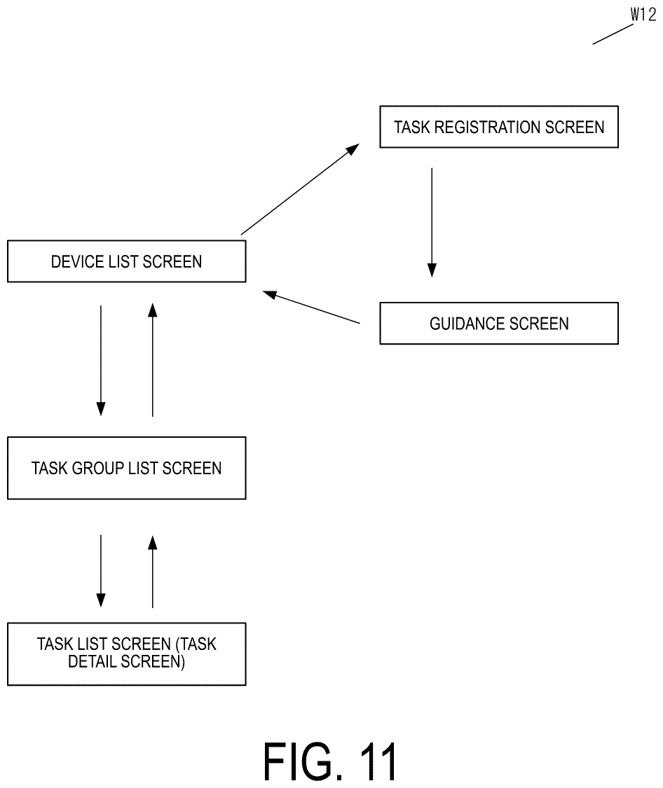

FIG. 11 is a diagram for describing transition of the management screen provided by the server device 10, and the management screen will be described as the management screen or the display screen provided by the server device 10.

First, the server device 10 provides, for example, the terminal device with a device list screen that displays information related to the target device. The device list screen is a screen that displays the status of each target device (the image forming device 20 or another device (for example, a display device)).

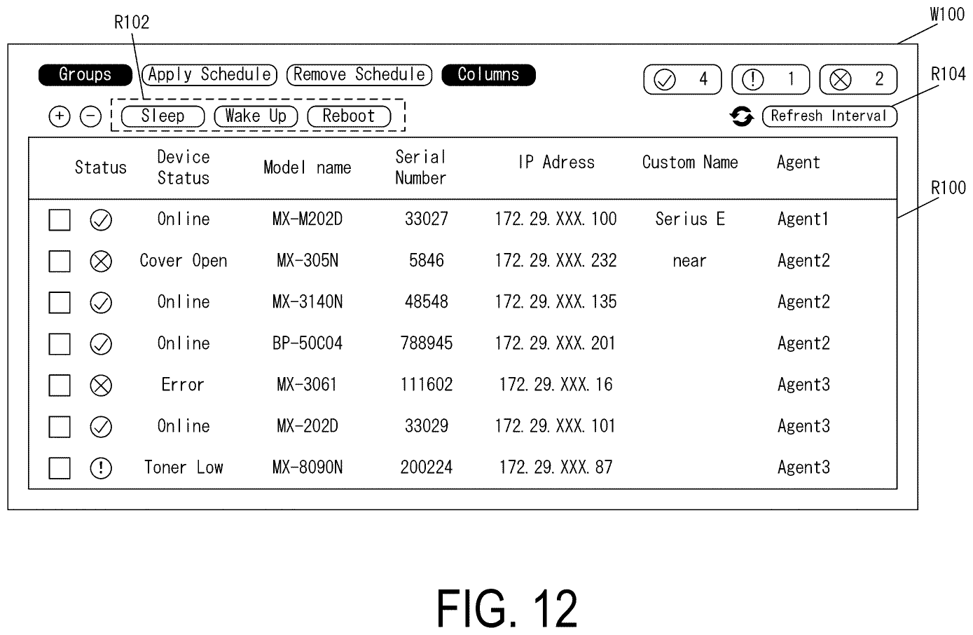

FIG. 12 illustrates a schematic diagram of a device list screen. A display screen W100 in FIG. 12 is an example of the device list screen that displays a list of target devices. On the device list screen, a list of target devices is displayed in a region R100. In a region R102, buttons for tasks from which the user can select are displayed. Selection of a button by the user may cause the target devices (image forming devices 20) related to the corresponding task to be narrowed down and displayed. In a case that selection is made in the region R102 after the image forming device 20 is selected, the task can be assigned to the image forming device 20 and registered in the task list.

A refresh button is displayed in a region R104. In a case that the user selects the refresh button, the server device 10 may perform processing for acquiring the status of the target device (image forming device 20).

The user uses the device list screen to transition to a screen for registering, in the task list, the task for the image forming device 20 as the target device. For example, in a case that the user selects a check button in a display screen R100 in FIG. 12 and selects a task button in the region R102, the task for the selected device can be registered.

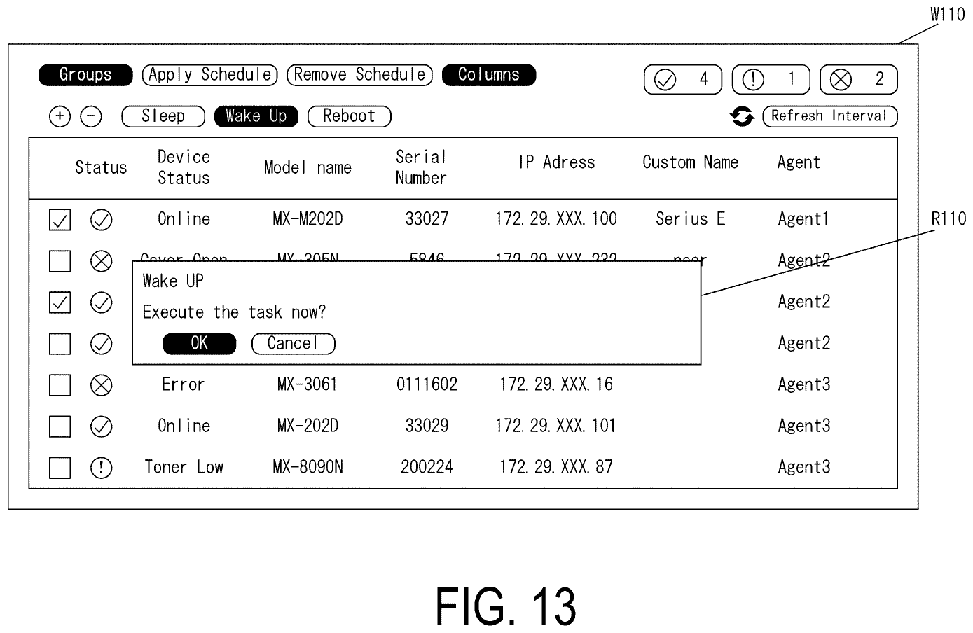

In a case that the task is registered, the controller 100 transitions to a task registration screen and indicates to the user that the task has been registered. An example of the task registration screen is a display screen W110 in FIG. 13.

For example, one or multiple target devices are selected from the target devices displayed in a list on the task list screen, and a registration button (for example, a “Wake UP button” indicating a task that the user desires to register in the target device) is selected. Thus, the selected task is registered in the image forming device 20 corresponding to the selected button.

After the task registration, the controller 100 may display a guidance screen indicating that the task has been registered.

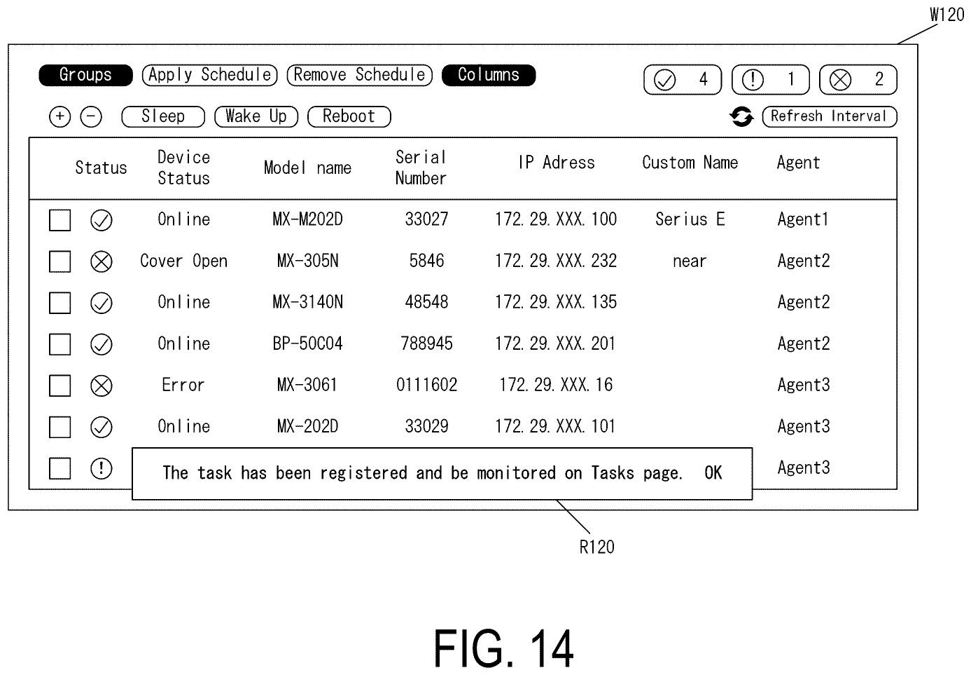

For example, FIG. 14 is an example of a display screen W120 illustrating a guidance screen. The display screen W120 is a screen on which a guidance message is displayed in a lower region R120.

Subsequently, in a case that the user desires to check the status of the task, the terminal device displays a task group list screen. For example, a mode switching button may be used to switch between the device list screen and the task group list screen for display. Switching may be performed between the screens at predetermined time intervals.

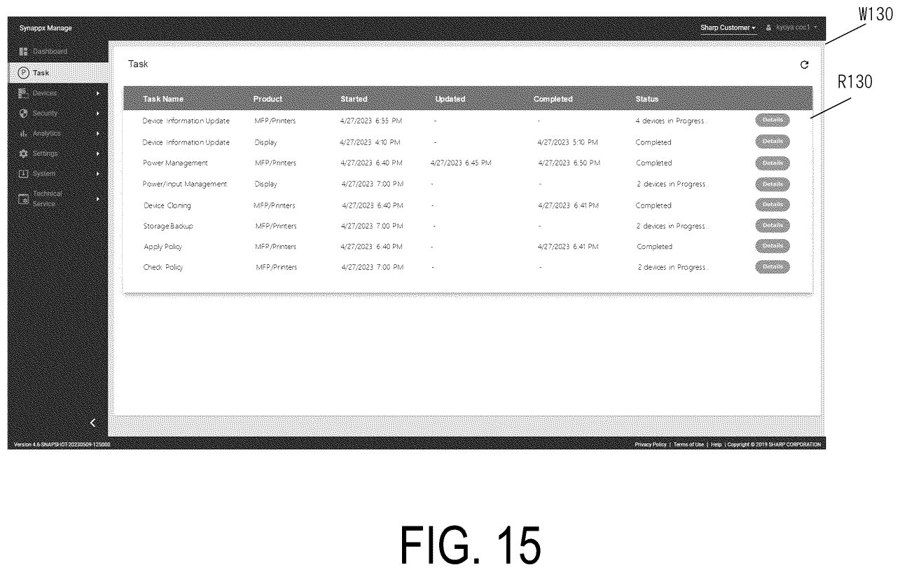

For example, FIG. 15 is an example of a display screen W130 illustrating the task group list screen. In the display screen W130, a task group list is displayed for each task group in a region R130. The progress status of each of the tasks belonging to the task group is displayed as “Status”.

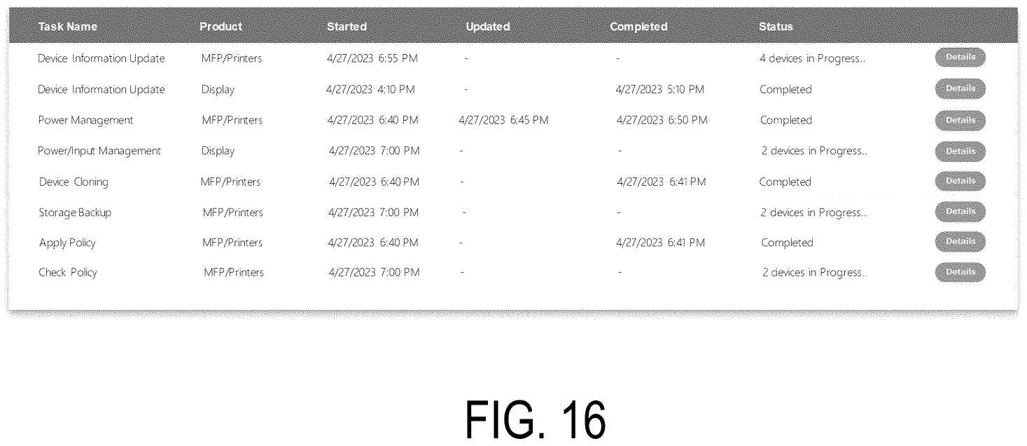

FIG. 16 is an enlarged view of the region R130. In the region R130, each of the task groups is displayed as a task group list. The task groups may be displayed in different rows for the respective device types. For example, in FIG. 16, “MFP/Printers” and “Display” are displayed in different rows.

The task group list indicates the start time of each task group and the completion time corresponding to the date and time of completion of all of the tasks included in the task group. Since the statuses of the tasks belonging to the task group are displayed, the user can easily recognize the statuses of the tasks included in the task group.

Here, selection of a detail button (for example, a Detail button) on the task group list screen in FIG. 15 (region R130 in FIG. 16) causes the screen to transition to a task list screen (task detail screen).

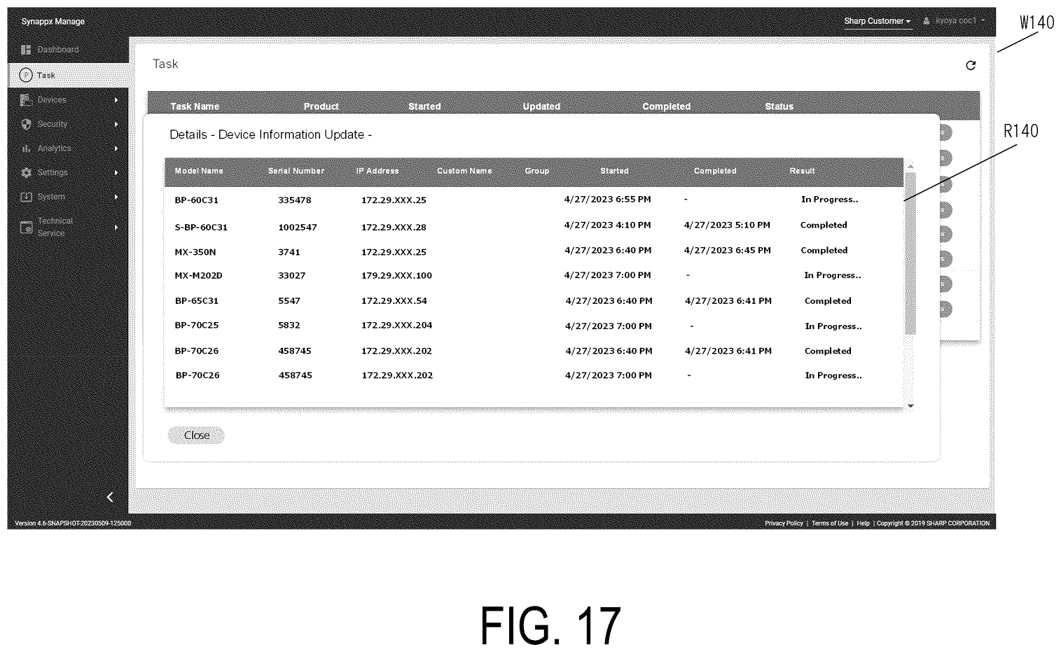

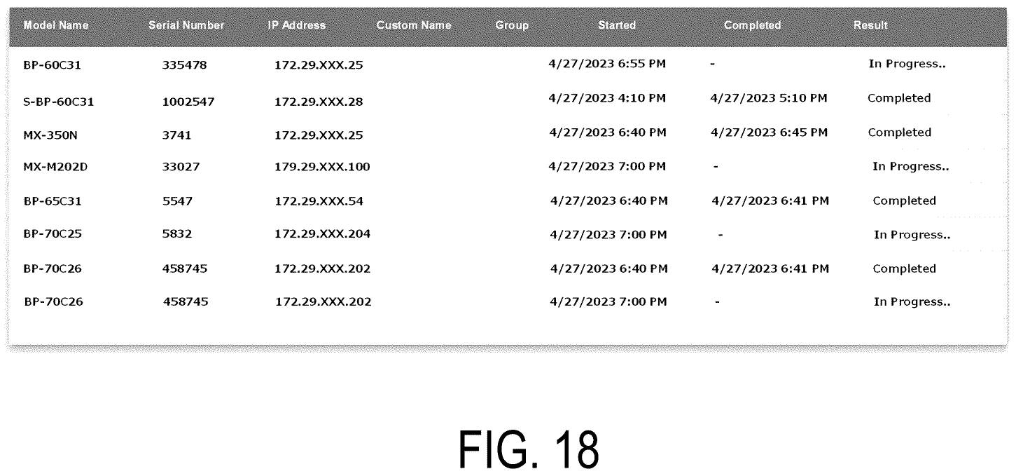

For example, FIG. 17 is an example of a display screen W140 illustrating the task list screen. On the display screen W140, a task list of tasks included in the task group is displayed in a region R140. FIG. 18 is an enlarged view of the region R140. In the region R140, all of the tasks belonging to the task group are displayed. The task list indicates information regarding each target device, the start date and time and the completion date and time for the task in the target device, and the status of the task in the target device.

As described above, according to the present embodiment, instead of management for each task for which an operation has been indicated, centralized control can be performed for each target device in the task group to which the task belongs, based on the type or name of the task (operation). As a result, the task group list and the task list are provided on a management page in such a manner as to have predetermined sizes, allowing complexity to be eliminated. For example, a task group management screen illustrated in FIG. 15 and a task list management screen illustrated in FIG. 17 are provided in fixed sizes, and can be expected to produce the effect of being visually and functionally easily managed by the user. The server device 10 can acquire the task statuses from the target devices and collectively display the task statuses in the task group. Accordingly, even in a case that the server device 10 and the target device do not communicate with each other in real time, results can be interactively displayed. In other words, even in a case of coexistence of a target device from which the status of the task is easily acquired by real-time communication with the server device 10 and a target device from which the status of the task is difficult to acquire due to a failure to communicate with the server device 10 in real time, the user can manage and check the progress without confusion.

### 2. Second Embodiment

A second embodiment includes performing task management processing different from that in the first embodiment.

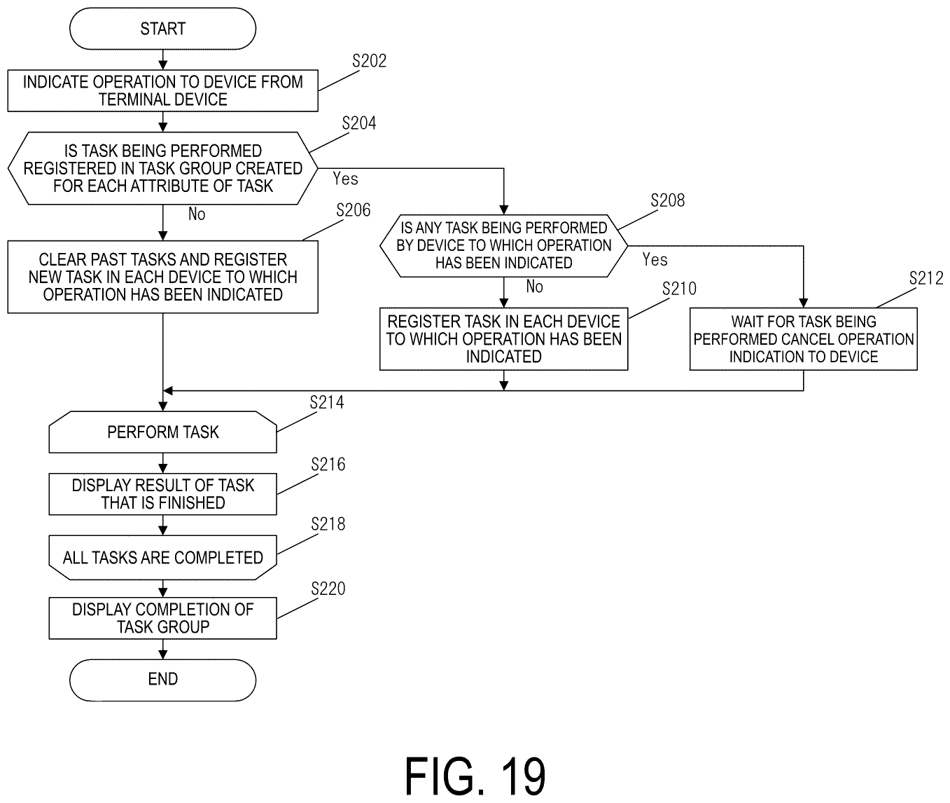

The second embodiment has the same hardware and software configurations as the first embodiment. FIG. 19 is a diagram for describing operations of the system 1 according to the second embodiment. Hereinafter, differences from the first embodiment will be mainly described, and other processing operations and configurations are substantially the same as those of the first embodiment.

First, the terminal device 30 (controller 300) transmits the task for the device to be managed (image forming device 20) to the server device 10 based on an operation indication from the user (step S202). The server device 10 (the controller 100) acquires information regarding the target device (the image forming device 20) in which the task is registered and information regarding the task.

Subsequently, the controller 100 determines whether the task being performed is registered in the task group created for each attribute (type) of the task (step S204).

Here, in a case that the task being performed is not registered in the task group (for example, in a case that all of the tasks are completed), the past tasks are deleted, and a new task is registered for each target device acquired in step S202 (step S204; No->step S206).

In a case that the task being performed is registered in the task group, the controller 100 determines whether any task is being performed in the device acquired in step S202 (step S208).

Then, in a case that no task is being performed, the controller 100 newly registers the designated task in the task list for each target device acquired in step S202 (step S208; No->step S210).

In a case that a task is being performed, the controller 100 cancels the designated task for each target device acquired in step S202 (step S208; Yes->step S212).

Then, the target device (for example, the controller 200 of the image forming device 20) performs control for performing the task (step S214).

Here, the server device 10 may periodically acquire the status of a job from the target device and display the result of the task that is finished (step S216). In a case that all of the tasks included in the task group are completed (step S218), the controller 100 indicates completion of the task group (step S220).

### 3. Third Embodiment

A third embodiment is an embodiment in which devices performing tasks in the same task group are stored in the task group list.

The third embodiment has the same hardware and software configurations as the first embodiment. Hereinafter, differences from the first embodiment will be mainly described, and other processing operations and configurations are substantially the same as those of the first embodiment.

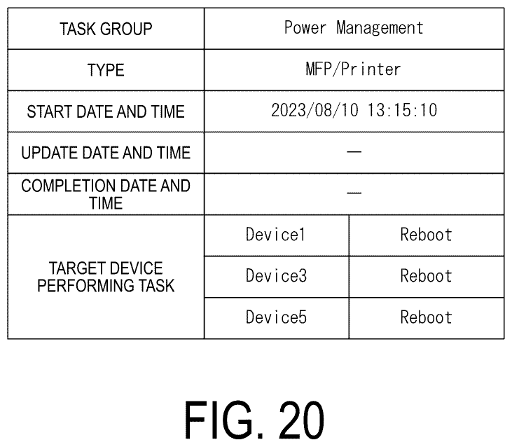

FIG. 20 is a diagram illustrating an example of the task group list in the third embodiment. FIG. 20 replaces the example of the task group list illustrated in FIG. 7C, and this task group list stores, in addition to the information in the first embodiment, information related to the target device in which the task is currently performed. Note that the task group list may store information for performing exclusive control on the task to be registered. Here, the target device in which the task is being performed includes a target device in which the task has not been completed, and may include, for example, a target device in which the task is pending or a target device in which the task has not been processed yet.

In the example of the task group list of FIG. 20, the task for the target device is also stored, but the information related to the target device may be exclusively stored. Although the information regarding the target device is designated as “DEVICE1” in FIG. 20 for description, information for identifying the target device (for example, identification information such as a serial number and an IP address) may be stored.

For example, in step S105 in FIG. 10, the controller 100 can determine, by referencing the task group list, whether any task is already present for the same device in which the task is to be registered.

In other words, the controller 100 identifies, from the task group list, the same task group as the task to be registered. Then, by referencing the task group list, whether the task group list includes the target device performing the task to be currently registered, which has been acquired in step S102.

As described above, according to the present embodiment, referencing the task group list enables determination of whether the task group includes a task in the same task group as the task for the same device.

### 4. Variations

The present disclosure is not limited to the embodiments described above and can be changed in various manners.

In other words, embodiments obtained by combining technical mechanisms appropriately changed without departing from the gist of the disclosure are also included in the technical scope.

In the above-described embodiment, the image forming device has been described as an example of the information processing device. However, the present disclosure is applicable to other information processing devices. For example, an example of the information processing device may be a smartphone or a tablet. The information processing device may be a home appliance (for example, an air conditioner, a refrigerator, a television, or the like) equipped with an IoT function. The information processing device is not limited to a stationary device, and may be a portable device or an in-vehicle device, for example. For example, the in-vehicle device may be a device such as a car navigation system.

Although each of the above-described embodiments is separated into some aspects for convenience of description, the aspects can be combined together for execution within an allowable range. Any of the technologies described herein is intended to acquire the right through amendment, divisional application, or the like.

The programs running on each device in the embodiments are programs for controlling a CPU or the like (programs for causing a computer to function) to realize the aforementioned functions in the embodiments. The information handled by these devices is temporarily accumulated in a transitory storage device (for example, a RAM) at the time of processing, is then stored in a storage device such as any of various ROMs or an HDD, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In a case where the programs are distributed to the market, the programs can be stored and distributed in a portable recording medium, or can be transferred to a server computer connected via a network such as the Internet. In this case, it is a matter of course that the storage device of the server device is also included in the disclosure.

Instead of being stored in the device, the above-described data may be stored in an external device and appropriately called. For example, the data may be stored in a Network Attached Storage (NAS) or may be stored on a cloud.

It should be noted that the scope of the disclosure is not limited to the configurations explicitly described herein, and a combination of technologies disclosed herein is also included in the scope thereof. Patentable configurations of the disclosure are set forth in the appended claims, but configurations not recited in the claims are not intended to be excluded from the scope.

In the above-described specification, the description of “in a case that” is described as one example, and the configuration is not limited to the described content. These and other configurations are also disclosed to the extent that the configurations are obvious to a person skilled in the art, and are intended to acquire the right.

The processing and the flow of data described herein with order are not limited to the described order. For example, partly removed processing and the components rearranged in a new order are also disclosed and intended to acquire the right.

Although the functions described in the embodiments are described as being performed in the respective devices, the functions may be realized in one device or using an external server.

Each functional block or various features of the device used in the above-described embodiments may be implemented or performed by an electric circuit, for example, an integrated circuit or multiple integrated circuits. An electrical circuit designed to perform the functions described herein may include a general-purpose processor, a digital signal processor (DSP), an application specific integrated circuit (ASIC), a field programmable gate array (FPGA) or other programmable logic device, discrete gate or transistor logic, discrete hardware components, or a combination thereof. A general-purpose processor may be a microprocessor, or any known processor, controller, microcontroller, or state machine. The above-described electric circuit may be constituted by a digital circuit or an analog circuit. In addition, in a case where an integrated circuit technology that replaces the current integrated circuit becomes available due to advancement of the semiconductor technology, one or more aspects of the present disclosure can use a new integrated circuit based on the new integrated circuit technology.

1. A management device capable of communicating with a device to be managed that performs a task, the management device comprising:
a storage that stores a task list used to manage the task; and
a controller,
wherein the controller
acquires the task to be performed in the device to be managed and information regarding the device to be managed,
generates a task group in a case that no task group is present to which the acquired task belongs, and
registers the acquired task in the task list in a case that a task group is present to which the acquired task belongs, and the task for the device to be managed is not present in the task group.

2. The management device according to claim 1, wherein
in a case that a task group is present to which the acquired task belongs, and a task for the processing device is already present in the task group, the controller cancels the acquired task.

3. The management device according to claim 1, wherein
the controller deletes the task group in a case that all of the tasks belonging to the task group are completed or in a case that all of the tasks belonging to the task group are completed and a next new task group is generated.

4. A task management system comprising:
a terminal device that receives an indication to perform a task to a device to be managed, the device to be managed that performs the task; and
a management device that stores a task list used to manage the task, wherein
the management device
acquires the task to be performed in the device to be managed and information regarding the device to be managed,
generates a task group in a case that no task group is present to which the acquired task belongs, and
registers the acquired task in the task list in a case that a task group is present to which the acquired task belongs, and the task for the device to be managed is not present in the task group, and
the device to be managed performs the task registered in the task list.

5. The task management system according to claim 4, wherein
the terminal device
displays a first display screen including a list of the task group, and
in a case that the task group is selected, displays a second display screen including a task list of tasks belonging to the selected task group.

6. The task management system according to claim 5, wherein
the terminal device
displays, in the list of the task group, statuses of the tasks belonging to the task group.

7. The task management system according to claim 6, wherein
the terminal device
displays, as the statuses of the tasks, the number of tasks being performed in the device to be managed among the tasks belonging to the task group.

8. A task management method in a management device capable of communicating with a device to be managed that performs a task, the task management method comprising:
storing a task list used to manage the task;
acquiring the task to be performed in the device to be managed and information regarding the device to be managed;
generating a task group in a case that no task group is present to which the acquired task belongs; and
registering the acquired task in the task list in a case that a task group is present to which the acquired task belongs and the task for the device to be managed in the task group is not present in the task group.
